(19) United States
(12) Patent Application Publication
(10) Pub. No.: US 2022/0415037 A1
(43) Pub. Date: Dec. 29, 2022

(54) VIDEO CORRUPTION DETECTION

(71) Applicant: Meta Platforms, Inc., Menlo Park, CA (US)

(72) Inventors: Wen Zhang, Fremont, CA (US); Andrew William Borba, Seattle, WA (US); Nicholas Jacob Ruff, Issaquah, WA (US)

(21) Appl. No.: 17/840,354

(22) Filed: Jun. 14, 2022

Related U.S. Application Data
(60) Provisional application No. 63/214,685, filed on Jun. 24, 2021.

(51) Int. Cl. G06V 10/98; G06T 7/00; G06T 7/174; G06N 20/00

(52) U.S. Cl. CPC G06V 10/98; G06T 7/0002; G06T 7/174; G06N 20/00; G06T 2207/20132

(57) ABSTRACT

Systems, methods, and non-transitory computer-readable media can be configured to train a machine learning model to identify corrupted frames of videos based on training data including video frames exhibiting corruption that is intentionally generated. A frame of a video can be provided to the trained machine learning model. A score indicating a likelihood that the frame of the video exhibits corruption can be determined based on the trained machine learning model.

### CROSS-REFERENCE TO RELATED APPLICATIONS

This application claims priority to U.S. Provisional Patent Application No. 63/214,685, filed on Jun. 24, 2021 and entitled “Video Corruption Detection,” which is incorporated herein by reference in its entirety.

### FIELD OF THE INVENTION

The present technology relates to the field of digital video processing. More particularly, the present technology relates to detection of corrupted video.

### BACKGROUND

Today, people often utilize computing devices (or systems) for a wide variety of purposes. For example, users can utilize computing devices to access a content sharing platform, such as a social networking system (or service). The users can utilize the computing devices to interact with one another, post content items, and view content items via the content sharing platform. For example, users may publish videos through a social networking system for consumption by others. The number of such videos continues to grow.

### SUMMARY

Various embodiments of the present technology can include systems, methods, and non-transitory computer readable media configured to train a machine learning model to identify corrupted frames of videos based on training data including video frames exhibiting corruption that is intentionally generated. A frame of a video can be provided to the trained machine learning model. A score indicating a likelihood that the frame of the video exhibits corruption can be determined based on the trained machine learning model.

In some embodiments, the systems, methods, and non-transitory computer readable media further generate corruption in a video to create a corrupted version of the video.

In some embodiments, the generating corruption in the video comprises: modifying a bitstream associated with the video while the video is playing.

In some embodiments, the systems, methods, and non-transitory computer readable media further record frames of the corrupted version of the video; and record frames of an uncorrupted version of the video.

In some embodiments, the frames of the corrupted version of the video and the frames of the uncorrupted version of the video are recorded based on a predetermined sampling rate.

In some embodiments, the systems, methods, and non-transitory computer readable media further transform the frames of the corrupted version of the video and the frames of the uncorrupted version of the video, wherein the transforming comprises: cropping a frame of the corrupted version of the video so that corruption appearing in the frame is preserved.

In some embodiments, the systems, methods, and non-transitory computer readable media further convert each frame of the frames of the corrupted version of the video and the uncorrupted version of the video and an associated label into a data representation for training the machine learning model. The data representation can include pixel values of the frame.

In some embodiments, the data representation can be a multidimensional array or a tensor.

In some embodiments, the training data can include paired frames including a first frame and a second frame that are identical except for corruption appearing in the first frame.

In some embodiments, the systems, methods, and non-transitory computer readable media further select frames of the video, including the frame of the video, at a selected sampling rate; and provide the selected frames of the video to the machine learning model to score the frames.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including a video corruption detection module, according to an embodiment of the present technology.

FIG. 2 illustrates an example training data module, according to an embodiment of the present technology.

FIG. 3A illustrates an example functional block diagram of preprocessing training data, according to an embodiment of the present technology.

FIG. 3B illustrates an example functional block diagram of further preprocessing training data and training a machine learning model, according to an embodiment of the present technology.

FIG. 4 illustrates an example functional block diagram of applying a machine learning model to identify corrupted frames of videos, according to an embodiment of the present technology.

FIG. 5A illustrates a first example method, according to an embodiment of the present technology.

FIG. 5B illustrates a second example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Today, people often utilize computing devices (or systems) for a wide variety of purposes. For example, users can utilize computing devices to access a content sharing platform, such as a social networking system (or service). The users can utilize the computing devices to interact with one another, post content items, and view content items via the content sharing platform. For example, users may publish videos through a social networking system for consumption by others. A content sharing platform can provide a vast quantity of such videos. Most videos can be published through the content sharing platform with little issue.

However, in some instances, videos can become corrupted. Corruption can occur at various stages, such as when a video is captured, when the video is uploaded to a content sharing platform, when the video is encoded by the content sharing system, when the video is transmitted to a user for consumption, or when the video is played on a client device associated with the user. A corrupted video can undermine the efforts of its owner to provide interesting content to a relevant community supported by the content sharing platform. Further, a corrupted video can detrimentally impact the user experience of a person who accessed the video. In either instance, the potential of the content sharing system is compromised. Accordingly, conventional technologies have been attempted to identify corrupted videos among a potentially massive total number of videos hosted by a content sharing platform. Conventional technologies tend to require extensive human intervention or are otherwise not scalable. Because they are not scalable, such conventional technologies do not meet the challenge presented by the tremendous number of videos that would require assessment for potential corruption. The substantial problems with efficiently identifying corrupted videos further impedes the acquisition of sufficient amounts of relevant data to productively leverage artificial intelligence and machine learning techniques to discover video corruption.

An improved approach rooted in computer technology overcomes the foregoing and other disadvantages associated with conventional approaches specifically arising in the realm of computer technology. In various embodiments, the present technology relates to identification of corrupted content items, such as videos. Video can be, for example, video on demand that is stored on a content sharing platform or video that is broadcasting live to users through a content sharing platform. In relation to preprocessing training data, corruption can be intentionally generated in the video as the video is playing. For example, bits in the bitstream of the video can be randomly flipped to deliberately cause corruption in the video as rendered. For a device on which a corrupted version of the video is played, frames (or screens) that exhibit corruption can be recorded or otherwise extracted. For a device on which an uncorrupted version of the video is played, frames without corruption, which are otherwise the same as the frames that exhibit corruption, can be recorded or extracted. Various processing, such as scaling, can be applied to the frames so that they have a desired uniform dimension. Each frame can be transformed into a data representation, such as a multidimensional array or a tensor, of pixels values of the frame. A data representation associated with a frame that exhibits corruption and corresponding label indicating the presence of corruption can be utilized as a positive sample in a set of training data to train a machine learning model in a supervised learning process. A data representation of a frame that does not exhibit corruption and a label indicating the absence of corruption can be utilized as a negative sample. The two data representations can constitute an associated pair of training data. Data representations associated with additional frames can be generated in this scalable manner to populate the set of training data for optimal training of the machine learning model. The set of training data can be used to train the machine learning model. Once trained, the machine learning model in an evaluation phase can predict whether a frame of a video exhibits corruption or not. A determination of whether a video, or segment thereof, is corrupted can be based on an evaluation of a selection of frames of the video. More details relating to the present technology are provided below.

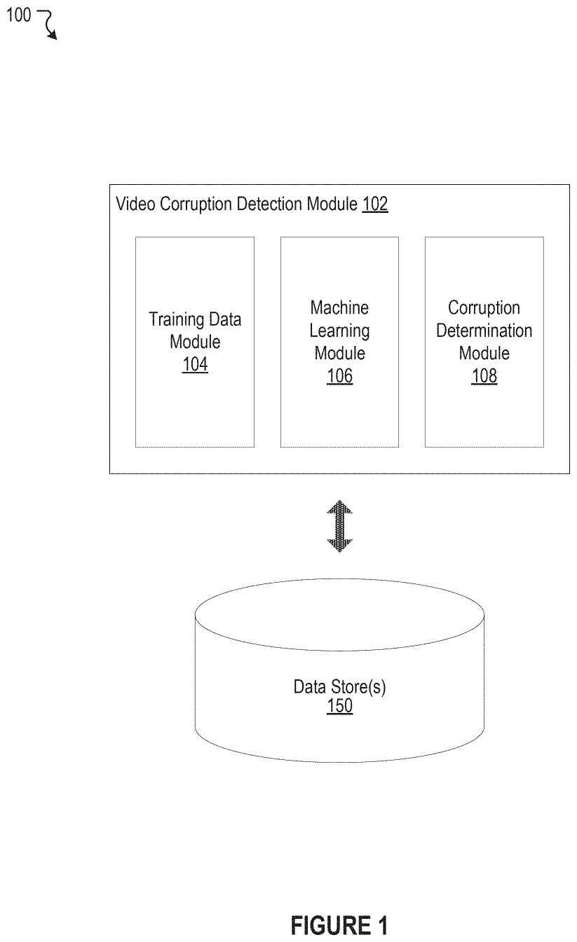

FIG. 1 illustrates an example system 100 including a video corruption detection module 102, according to an embodiment of the present technology. The system 100 can be associated with a content sharing platform or system, such as a social networking system. Although a social networking system may be referenced in various examples discussed herein, the present technology applies to any type of content sharing platform or system, messaging platform or system, or the like. As shown in the example of FIG. 1, the video corruption detection module 102 can include a training data module 104, a machine learning module 106, and a corruption determination module 108. In some instances, the example system 100 can include at least one data store 150 in communication with the video corruption detection module 102. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the training data module 104, the machine learning module 106, and the corruption determination module 108 can be implemented in any suitable combinations.

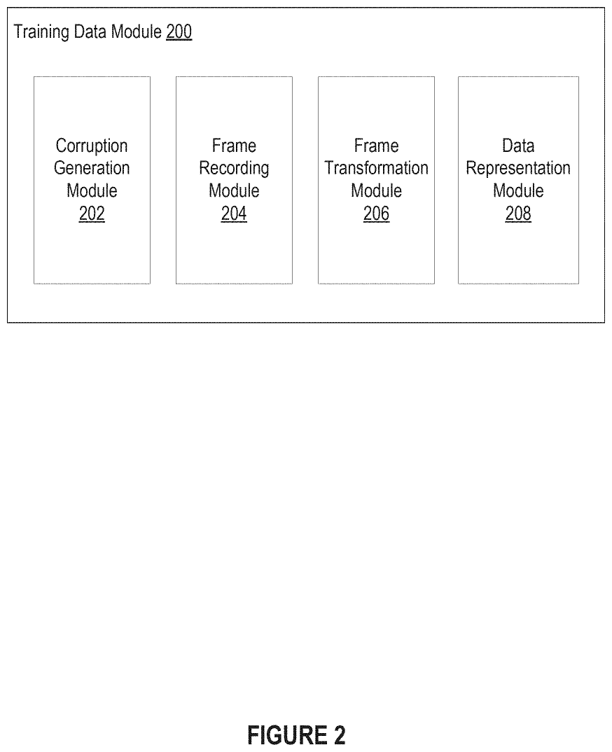

The training data module 104 can generate training data to train a machine learning model to predict whether a frame (or screen) of a video exhibits corruption. FIG. 2 illustrates an example training data module 200 that can implement functionality of the training data module 104, according to an embodiment of the present technology. The training data module 200 can include a corruption generation module 202, a frame recording module 204, a frame transformation module 206, and a data representation module 208. In some embodiments, the corruption generation module 202 can be implemented by or in a media player (e.g., video player) or decoder. The corruption generation module 202 can receive content items, such as video. Video can include, for example, video that is stored for access by users on demand (VOD). Video also can include, for example, video that is broadcasting live to users. The video received by the corruption generation module 202 can be in any suitable format, such as mp4 or another type of encoding or compression format. The corruption generation module 202 can support a platform or framework to intentionally generate and inject various types of corruption in a video as the video is playing. Corruption generated by the corruption generation module 202 can be manifested as various types of visual artifacts reflected in a video, such as blockiness (e.g., green blocks, pink blocks). The intentional generation of corruption supports the ability of the video corruption detection module 102 and, in particular, training of a machine learning model thereof to identify corruption in frames of videos.

The corruption generation module 202 can create corruption in various ways. For example, the corruption generation module 202 can randomly flip bits in a bitstream of a video as the video is playing to generate corruption in the rendered video. In general, when relatively more bits are flipped, relatively higher levels of corruption are generated. Inversely, when relatively fewer bits are flipped, relatively lower levels of corruption are generated. In some embodiments, the corruption generation module 202 can apply other techniques instead of or in addition to bit flipping to generate corruption in a video. The corruption generation module 202 also can generate various levels (or amounts) of video corruption. For example, the corruption generation module 202 can be configurable to apply a “heavy” level of corruption, a “medium” level of corruption, or a “light” level of corruption. Depending on the implementation, other levels of corruption and designations of the levels are possible. In some instances, the corruption generation module 202 can generate corruption of a video based on a corruption configuration file. The corruption configuration file can specify, for example, a type of corruption to generate, a technique to generate the corruption, a level or amount at which the corruption should be generated, or any combination thereof.

The frame recording module 204 can generate recordings or extractions of frames (or screens) of videos appearing in displays of devices that are playing the videos. While “recordings” are sometimes herein referenced for purposes of illustration, the present technology generally applies to any type of extractions of frames (or screens) of videos. An uncorrupted version of a video can be played so that the video is rendered on a display of a device. A corrupted version of the same video can be played so that the corrupted video is rendered on a display of another device. The frame recording module 204 can record displayed frames of the uncorrupted video and displayed frames of the corrupted video on a frame-by-frame basis. The frame recording module 204 can select and record frames of a corrupted version of a video and an uncorrupted version of the video at a common selected frequency or sampling rate. In some embodiments, the recorded frames are associated and paired. Paired frames are identical, except for the appearance of corruption in one frame but not the other frame. For example, with respect to a corrupted version of a video, the frame recording module 204 can record frames exhibiting corruption at a predetermined frequency (e.g., every five seconds). In this example, with respect to an uncorrupted version of the same video, the frame recording module 204 can record the same frames, which do not exhibit corruption, at the predetermined frequency (e.g., every five seconds). Any suitable frequency at which to record frames can be selected. The frame recording module 204 can record a suitable number of frames to achieve an optimal set of training data to train a machine learning model to identify corrupted frames, as discussed in more detail herein. As discussed, in some embodiments, the frames can be paired and accordingly the number of corrupted frames and the number of uncorrupted frames can be equal. In some embodiments, the frames are not necessarily paired, and the number of corrupted frames and the number of uncorrupted frames may not be equal.

The frame transformation module 206 can perform additional transformation or processing on recorded or extracted frames (or screens). The frames can be recordings of frames rendered on displays of different dimensions or aspect ratios. Accordingly, the frames may reflect the different dimensions or aspect ratios. The frame transformation module 206 can adjust the size of the frames so that the frames have a uniform dimension or aspect ratio. For example, the frame transformation module 206 can scale the frames as needed to achieve a uniform dimension or aspect ratio (e.g., 224×224). A selection of a uniform dimension or aspect ratio can vary based on the implementation. In addition, the frame transformation module 206 can selectively crop frames to account for differences in aspect ratios between a video and a display on which the video is rendered. For example, a video can have a first aspect ratio (e.g., widescreen shot in 16×9). A display of a device on which the video appears can have a second aspect ratio that is different from the first aspect ratio. As a result, a recording of a frame of the video rendered on the display can include empty spaces in the frame. The frame transformation module 206 can selectively crop the frame so that the empty spaces are minimized or removed. The frame transformation module 206 also can selectively crop a frame to eliminate unimportant (non-media) pixels that were introduced in the screen recording process. For example, paired frames can include a first frame exhibiting corruption and a second frame that is the same as the first frame except without the corruption. Frames paired to reflect corruption in this manner can be included in a set of training data to optimize machine learning training. Accordingly, the frame transformation module 206 can crop a frame of a corrupted version of a video as needed while preserving corruption that appears in the frame.

The data representation module 208 can convert frames into data (or feature value) representations for training a machine learning model. The frames include frames in which corruption appears and frames in which corruption does not appear. In some embodiments, the data representation can be a multidimensional array or a tensor describing the frame. The data representation can include values for pixels in the frame. Pixel values can be expressed as RGB values or values of any other suitable color system or model. In some instances, pixel values can be normalized. For example, pixel values can be converted into values between 0 and 1 and then reflected in the data representation. A data representation also can contain a value of a label associated with a frame. A label can indicate whether or not the frame exhibits corruption. For example, a label value of 1 can indicate that the frame exhibits corruption while a label value of 0 can indicate the frame does not exhibit corruption. Data representations of frames along with their associated labels can constitute training data to train a machine learning model to identify corrupted frames of videos.

In FIG. 1, the machine learning module 106 can use data representations of frames to train a machine learning model to identify corruption in frames of a video. In some embodiments, the machine learning model can employ deep learning. In some embodiments, the machine learning model can be an artificial neural network (ANN), such as a residual neural network (ResNet). The machine learning module 106 can provide data representations of frames as training data to train the machine learning model in a supervised learning process. Data representations of each pair of frames, which include a frame exhibiting corruption and a corresponding frame not exhibiting corruption, can constitute a pair of training data. A data representation of the frame exhibiting corruption and associated label can be a positive sample in a set of training data. A data representation of the frame not exhibiting corruption and associated label can be a negative sample in the set of training data. The generation of positive samples and negative samples in the efficient, scalable manner as provided by the present technology enables optimal training of a machine learning model and avoids problems arising from flawed training data, such as overfitting. The machine learning model can be trained as a binary classifier to output a value that represents a likelihood that a frame of a video exhibits corruption.

In an evaluation phase, the machine learning module 106 can employ the trained machine learning model to predict the appearance of corruption in a frame of a video. The video can be, for example, a video that is accessible on demand (VOD) or a video that is being broadcast live. Certain frames of the video can be selected for recording or extraction. For example, frames can be selected for recording at a desired sampling rate (e.g., two frames per second). The sampling rate can be configurable. The frames can be processed by, for example, cropping and flipping, as described herein. A data representation for each frame (or processed frame) can be generated. In some embodiments, the data representation for each frame can be a multidimensional array or a tensor that includes pixel values for the frame. The data representation can be provided to the trained machine learning model. The trained machine learning model can output a prediction, or score, for the frame. The score can represent a likelihood that the frame exhibits corruption. In some embodiments, the score can fall within a range of 0 to 1, where a score of 1 indicates that the frame exhibits corruption and a score of 0 indicates that the frame does not exhibit corruption. Many variations are possible.

The corruption determination module 108 can determine whether a video is corrupted or not. The presence or absence of corruption in relation to a frame of a video can be based on a prediction provided by the machine learning model. The corruption determination module 108 can apply a selected threshold (e.g., 0.99) to determine the existence of corruption in a frame of a video at a desired confidence level. For example, the machine learning model can output a score indicating whether a frame exhibits corruption. If the score satisfies (e.g., is equal to or greater than) the selected threshold, the frame can be considered to exhibit corruption. If the score does not satisfy the selected threshold, the frame can be considered not to exhibit corruption. In some embodiments, a video can be considered corrupted, for example, when a number of frames in the video exhibiting corruption satisfies a threshold value. In other embodiments, a video can be considered corrupted when a ratio of the number of frames in the video (or portion thereof) exhibiting corruption divided by the total number of frames in the video (or portion thereof) satisfies a threshold value. The threshold values can vary based on the implementation. Many variations are possible.

In some embodiments, the corruption determination module 108 can specify a time window of a selected duration (e.g., 60 seconds). The corruption determination module 108 can apply the time window to a video. The portion of the video corresponding to the time window can be considered a segment of the video. For a given segment of the video, the corruption determination module 108 can determine a number of frames in the segment that exhibit corruption. A rule can be applied to determine whether the segment is considered to be corrupted. For example, a segment can be considered corrupted when a number of frames in the segment exhibiting corruption satisfies a threshold value. As another example, a segment can be considered corrupted when a ratio of the number of frames in the segment exhibiting corruption divided by the total number of frames in the segment satisfies a threshold value.

After the segment is characterized as corrupted or not corrupted, the corruption determination module 108 can shift or slide the time window by a selected duration of time (e.g., one second). The new portion of the video corresponding to the shifted time window is another segment of the video to be considered as corrupted or not. The corruption determination module 108 can continue this process iteratively, each time shifting the time window and determining whether an associated segment is corrupted or not. The process can conclude when the time window has extended to the end of the video. In some embodiments, a video can be considered corrupted, for example, when a number of segments in the video deemed corrupted satisfies a threshold value. In other embodiments, a video can be considered corrupted when a ratio of the number of segments in the video deemed corrupted divided by the total number of segments in the video satisfies a threshold value. Many other techniques to identify corrupted videos based on scores associated with frames of the videos as determined by the machine learning model are possible. In some embodiments, the corruption determination module 108 can take further action based on a determination that a video is corrupted. For example, the corruption determination module 108 can perform a look up of metadata associated with the video to determine source information regarding the video. The corruption determination module 108 can analyze the source information, such as an identification of the system used to encode the video, to determine the possible causes of the corruption. As another example, the corruption determination module 108 can provide a notice to the owner of a video on demand or a broadcaster of a live video about the presence of corruption in the video. The corruption determination module 108 also can take down (or remove) a video on demand or cease live broadcast of a video when the video is determined to be corrupted. Many variations are possible.

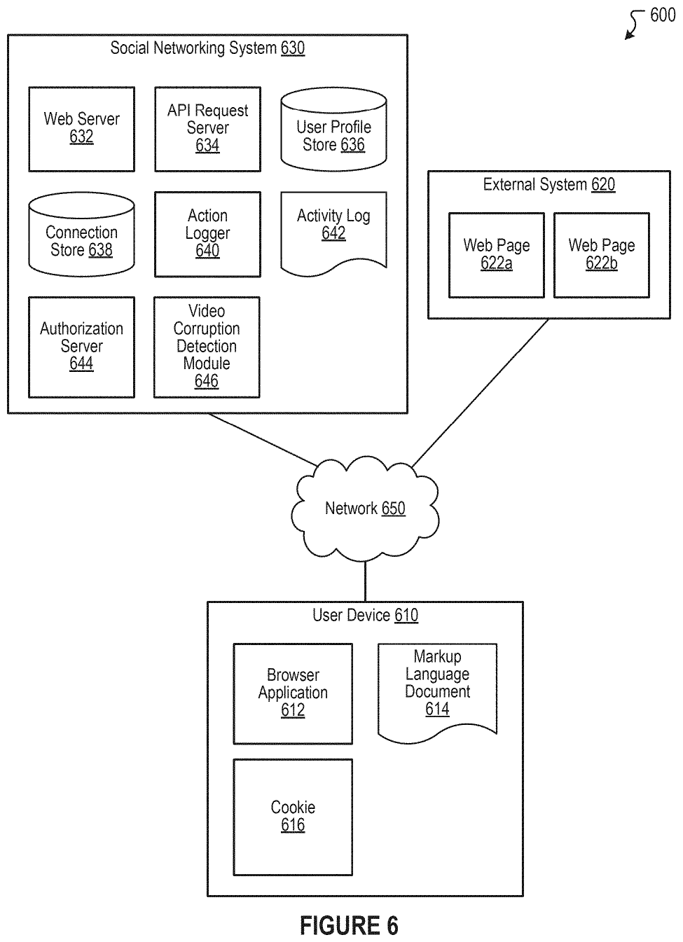

In various embodiments, the video corruption detection module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the video corruption detection module 102 can be, in part or in whole, implemented as software running on one or more computing devices or systems, such as on a server system or a client computing device. In some instances, the video corruption detection module 102 can be, in part or in whole, implemented within or configured to operate in conjunction with or be integrated with a social networking system (or service), such as a social networking system 630 of FIG. 6. Likewise, in some instances, the video corruption detection module 102 can be, in part or in whole, implemented within or configured to operate in conjunction with or be integrated with a client computing device, such as the user device 610 of FIG. 6. For example, the video corruption detection module 102 can be implemented as or within a dedicated application (e.g., app), a program, or an applet running on a user computing device or client computing system. The application incorporating or implementing instructions for performing functionality of the video corruption detection module 102 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The video corruption detection module 102 can be configured to communicate and/or operate with the data store 150, as shown in the example system 100. The data store 150 can be configured to store and maintain various types of data. In some implementations, the data store 150 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 150 can store information that is utilized by the video corruption detection module 102. For example, the data store 150 can store information associated with generation of training data to train a machine learning model to identify video corruption. It is contemplated that there can be many variations or other possibilities.

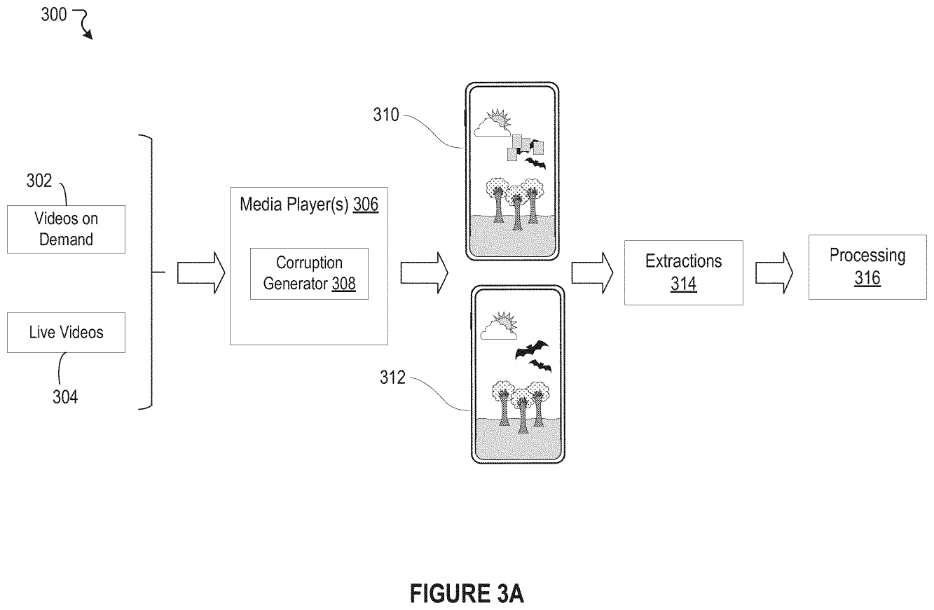

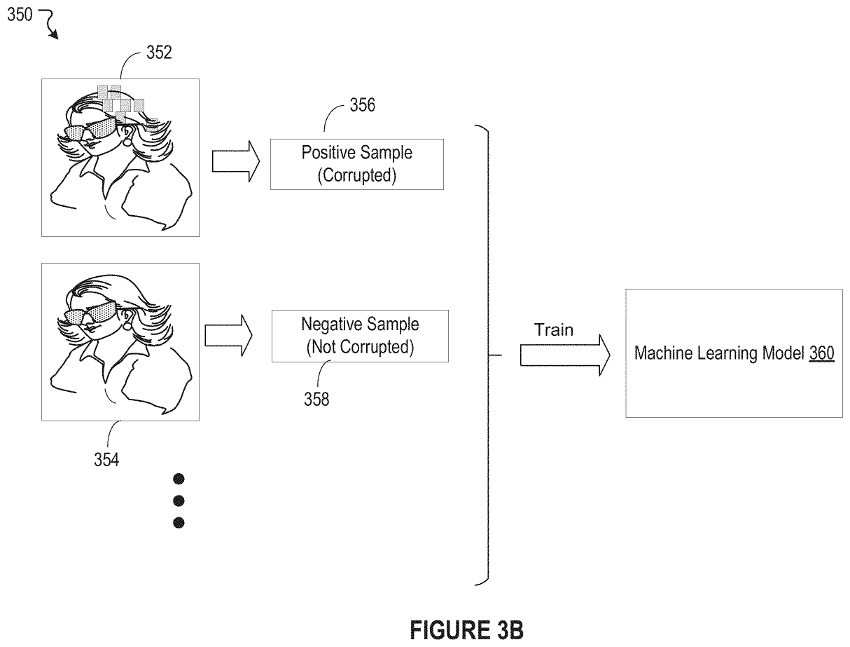

FIG. 3A illustrates an example functional block diagram 300 of preprocessing training data for a machine learning model to identify corrupted videos, according to an embodiment of the present technology. Videos, such as videos on demand 302 and live videos 304, can be provided to a media player 306. In some embodiments, the media player 306 can be implemented in various computing devices to play video. The media player 306 can be associated with or include a video decoder coupled to a corruption generator 308. The media player 306 can play a video without generating corruption in the video. For example, the media player 306 can play the video so that frames without generated corruption, such as frame 312, appear through a display of a computing device. The media player 306 also can play the video so that corruption is generated in the video. For example, the media player 306 can play the video so that frames exhibiting corruption, such as frame 310, appear through a display of a computing device. During play of the video, the corruption generator 308 can generate corruption in frames of the video. For example, the corruption generator 308 can reorder bits in the bitstream of the video during playing of the video to create corruption that appears in the frames of the video. As one example, the corruption generator 308 can implement a random bit flipping technique. In this example, the bit flipping technique can create corruption in the frames of the video that is manifested as blockiness as the video plays. The corruption generator 308 can generate other forms of corruption in video based on other techniques. Thus, the corruption appearing in the frame 310 is merely an illustration. Other forms of corruption can be generated to appear in frames of a video. The corruption generator 308 can be configured to vary the level of corruption to be generated in frames of a video.

Frames of the uncorrupted version of a video and the corrupted version of the video can be recorded or otherwise extracted as the video plays to generate extractions 314 of the frames. The frames to be extracted can be selected from the video at a desired sampling rate. Extracted frames of the corrupted version of the video can be analyzed to confirm that they exhibit a selected level of corruption. Likewise, extracted frames of the uncorrupted version of the video can be analyzed to confirm that they do not exhibit corruption. A frame of the corrupted version of the video and a frame of the uncorrupted version of the video that are identical, except for the appearance of corruption in the former, can be associated and paired. The frames can be subject to processing 316. For example, the frames can be cropped and scaled so that all frames are the same size to achieve a set of training data that is uniformly dimensioned. Paired frames can be cropped in a manner that preserves the corruption appearing in one of the frames. Although the functional block diagram 300 shows two frames 310, 312 for ease of illustration, the function block diagram 300 applies to any suitable number of frames that are appropriate to form a set of training data to optimally train a machine learning model to identify corrupted videos.

FIG. 3B illustrates an example functional block diagram 350 of further preprocessing training data and training a machine learning model to identify corrupted videos, according to an embodiment of the present technology. Paired frames of a video, such as a corrupted frame 352 and matching uncorrupted frame 354, have been extracted and processed, as discussed. The frame 352 can be associated with a label indicating the frame 352 is corrupted. The frame 354 can be associated with a label indicating the frame 354 is not corrupted. As mentioned, in some embodiments, the frames need not be paired. The frame 352 and the associated label can be transformed into a corresponding data representation. Likewise, the frame 354 and the associated label can be transformed into a corresponding data representation. Each data representation can be a multidimensional array or a tensor of pixel values of a corresponding frame as well as a label value for the frame. The data representation of the frame 352 is a positive sample 356 that is used to train a machine learning model 360. The data representation of the frame 354 is a negative sample 358 that is used to train the machine learning model 360. In some embodiments, the machine learning model 360 can be a binary classifier trained in a supervised learning process. In one instance, the machine learning model 360 can be a ResNet. Although only the two frames 352, 354 are shown for ease of illustration, the present technology applies to a significantly larger number of frames that are sufficient to optimally train a machine learning model to identify corrupted frames of videos. The number of frames selected to constitute a set of training data for training a machine learning model can depend on the implementation.

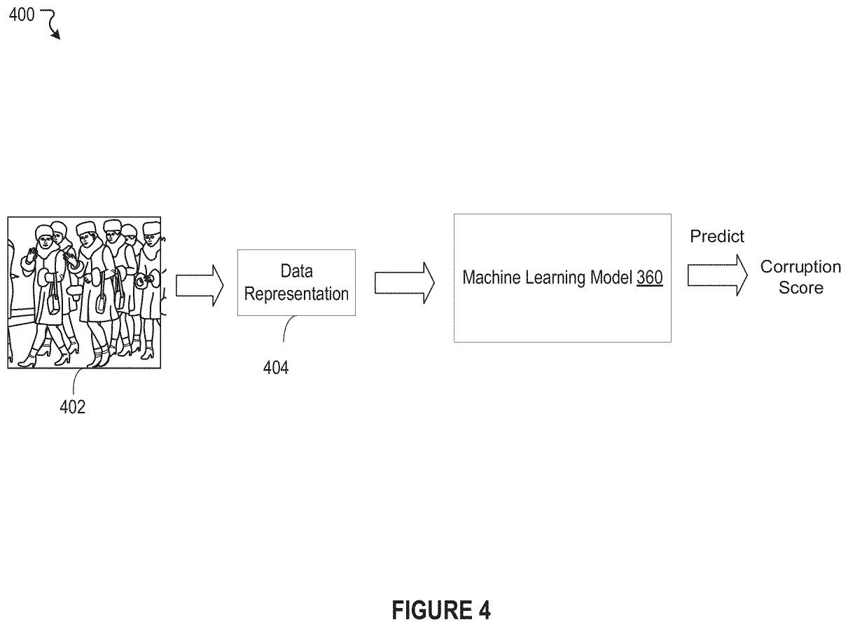

FIG. 4 illustrates an example functional block diagram 400 of applying a machine learning model to identify corrupted frames of a video, according to an embodiment of the present technology. A determination about whether frames of a video exhibit corruption is desired. Frames of the video are recorded or otherwise extracted. In some embodiments, frames of the video can be selectively sampled and extracted. The frames can be processed (e.g., scaled) so that they satisfy requirements (e.g., required dimensions) of feature data to be provided to a machine learning model. After processing, each frame, such as frame 402, can be transformed into a data representation 404. The data representation 404 can be, for example, a multidimensional array or a tensor that contains the pixel values of the frame 402. The data representation 404 can be provided to the machine learning model 360 for a prediction regarding whether the frame 402 exhibits corruption. The machine learning model 360 can output a score indicating whether the frame exhibits corruption. In some embodiments, the score can be a value between 0 and 1, with 1 indicating a highest likelihood of the presence of corruption and 0 indicating a lowest likelihood of the presence of corruption. As discussed, a determination about whether the video is deemed to be corrupted can be based on the presence or absence of corruption in various frames of the video.

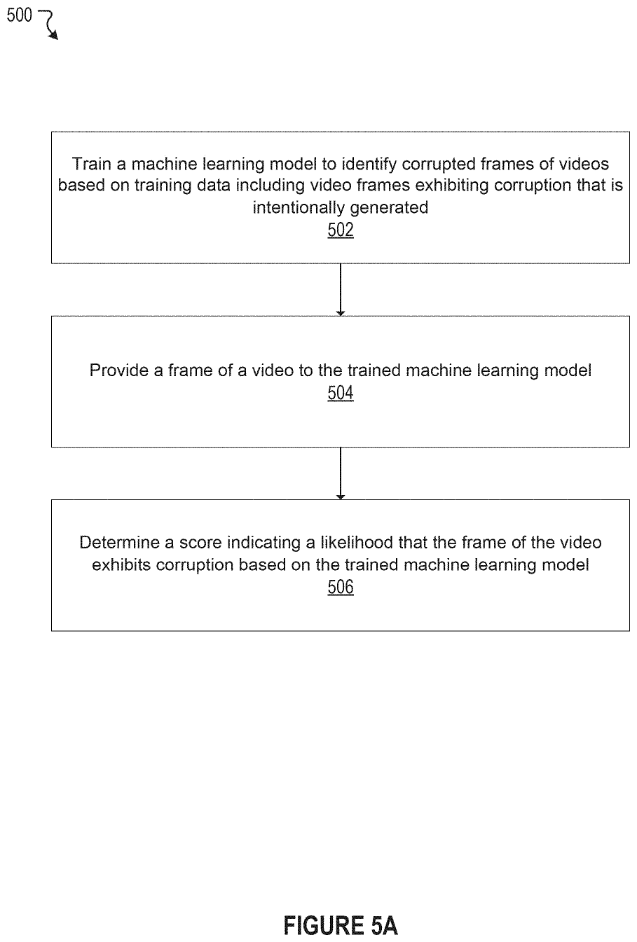

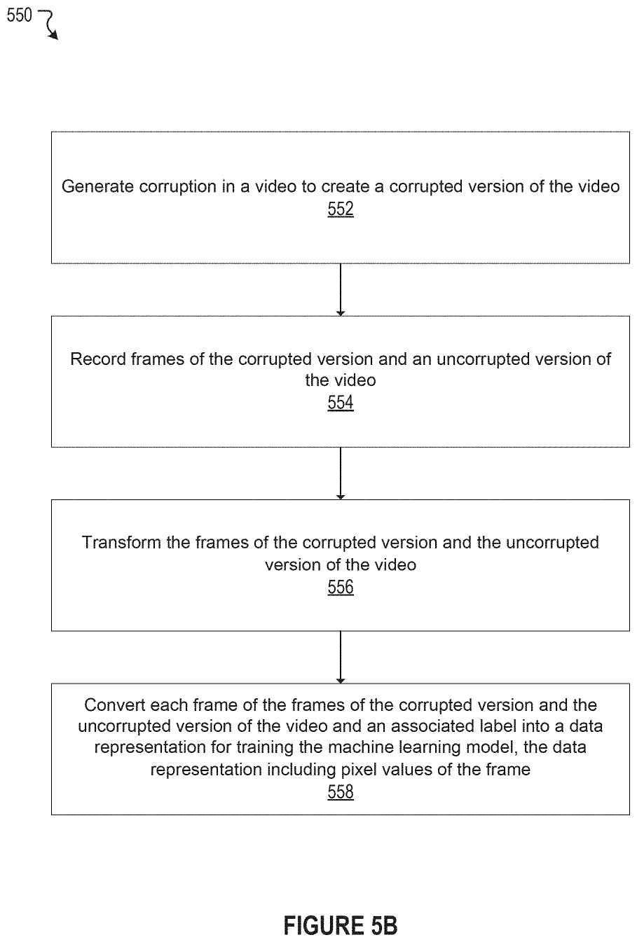

FIG. 5A illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 trains a machine learning model to identify corrupted frames of videos based on training data including video frames exhibiting corruption that is intentionally generated. At block 504, the example method 500 provides a frame of a video to the trained machine learning model. At block 506, the example method 500 determines a score indicating a likelihood that the frame of the video exhibits corruption based on the trained machine learning model.

FIG. 5B illustrates an example method 550, according to an embodiment of the present technology. It should be understood that there can be additional, fewer, or alternative steps performed in similar or alternative orders, or in parallel, based on the various features and embodiments discussed herein unless otherwise stated. At block 552, the example method 550 generates corruption in a video to create a corrupted version of the video. At block 554, the example method 550 records frames of the corrupted version and an uncorrupted version of the video. At block 556, the example method 550 transforms the frames of the corrupted version and the uncorrupted version of the video. For example, the example method 550 can crop a frame of the corrupted version of the video so that corruption appearing in the frame is preserved. At block 558, the example method 550 converts each frame of the frames of the corrupted version and the uncorrupted version of the video and an associated label into a data representation for training the machine learning model. The data representation can include pixel values of the frame.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a video corruption detection module 646. The video corruption detection module 646 can be implemented with the video corruption detection module 102, as discussed in more detail herein. In various embodiments, some or all functionality of the video corruption detection module 102 can be additionally or alternatively implemented by the user device 610. It should be appreciated that there can be many variations or other possibilities.

### Hardware Implementation

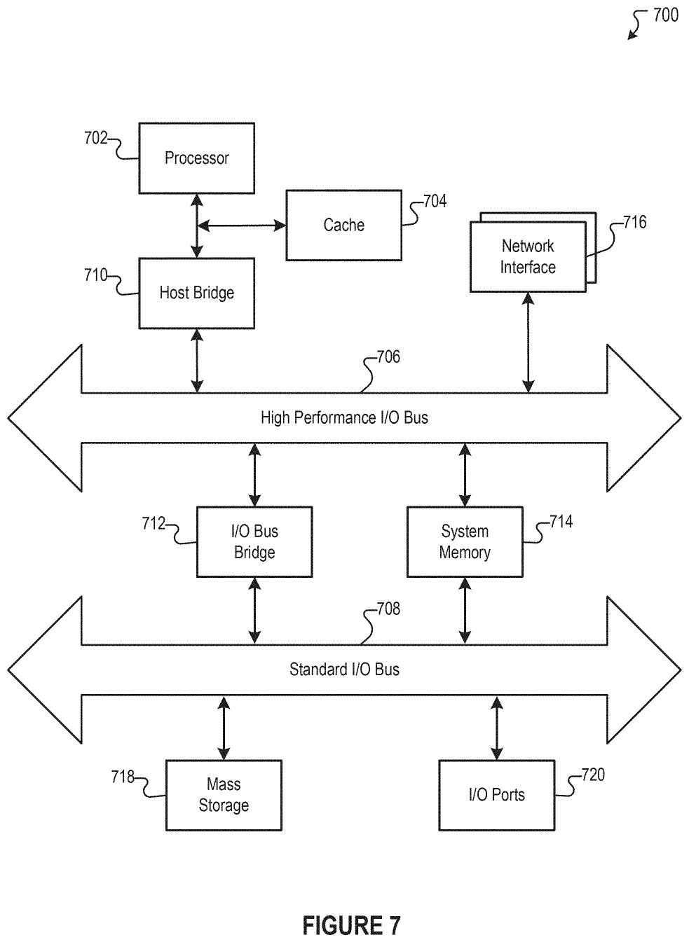

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and 1/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance 1/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
training, by a computing system, a machine learning model to identify corrupted frames of videos based on training data including video frames exhibiting corruption that is intentionally generated;
providing, by the computing system, a frame of a video to the trained machine learning model; and
determining, by the computing system, a score indicating a likelihood that the frame of the video exhibits corruption based on the trained machine learning model.

2. The computer-implemented method of claim 1, further comprising:
generating, by the computing system, corruption in a video to create a corrupted version of the video.

3. The computer-implemented method of claim 2, wherein the generating corruption in the video comprises:
modifying, by the computing system, a bitstream associated with the video while the video is playing.

4. The computer-implemented method of claim 2, further comprising:
recording, by the computing system, frames of the corrupted version of the video; and
recording, by the computing system, frames of an uncorrupted version of the video.

5. The computer-implemented method of claim 4, wherein the frames of the corrupted version of the video and the frames of the uncorrupted version of the video are recorded based on a predetermined sampling rate.

6. The computer-implemented method of claim 4, further comprising:
transforming, by the computing system, the frames of the corrupted version of the video and the frames of the uncorrupted version of the video, wherein the transforming comprises:
cropping, by the computing system, a frame of the corrupted version of the video so that corruption appearing in the frame is preserved.

7. The computer-implemented method of claim 4, further comprising:
converting, by the computing system, each frame of the frames of the corrupted version of the video and the uncorrupted version of the video and an associated label into a data representation for training the machine learning model, the data representation including pixel values of the frame.

8. The computer-implemented method of claim 7, wherein the data representation is a multidimensional array or a tensor.

9. The computer-implemented method of claim 1, wherein the training data includes paired frames including a first frame and a second frame that are identical except for corruption appearing in the first frame.

10. The computer-implemented method of claim 1, further comprising:
selecting, by the computing system, frames of the video, including the frame of the video, at a selected sampling rate; and
providing, by the computing system, the selected frames of the video to the machine learning model to score the frames.

11. A system comprising:
at least one processor; and
a memory storing instructions that, when executed by the at least one processor, cause the system to perform:
training a machine learning model to identify corrupted frames of videos based on training data including video frames exhibiting corruption that is intentionally generated;
providing a frame of a video to the trained machine learning model; and
determining a score indicating a likelihood that the frame of the video exhibits corruption based on the trained machine learning model.

12. The system of claim 11, further comprising:
generating corruption in a video to create a corrupted version of the video.

13. The system of claim 12, wherein the generating corruption in the video comprises:
modifying a bitstream associated with the video while the video is playing.

14. The system of claim 12, further comprising:
recording frames of the corrupted version of the video; and
recording frames of an uncorrupted version of the video.

15. The system of claim 14, further comprising:
converting each frame of the frames of the corrupted version of the video and the uncorrupted version of the video and an associated label into a data representation for training the machine learning model, the data representation including pixel values of the frame.

16. A non-transitory computer-readable storage medium including instructions that, when executed by at least one processor of a computing system, cause the computing system to perform:
training a machine learning model to identify corrupted frames of videos based on training data including video frames exhibiting corruption that is intentionally generated;
providing a frame of a video to the trained machine learning model; and
determining a score indicating a likelihood that the frame of the video exhibits corruption based on the trained machine learning model.

17. The non-transitory computer-readable storage medium of claim 16, further comprising:
generating corruption in a video to create a corrupted version of the video.

18. The non-transitory computer-readable storage medium of claim 17, wherein the generating corruption in the video comprises:
modifying a bitstream associated with the video while the video is playing.

19. The non-transitory computer-readable storage medium of claim 17, further comprising:
recording frames of the corrupted version of the video; and
recording frames of an uncorrupted version of the video.

20. The non-transitory computer-readable storage medium of claim 19, further comprising:
converting each frame of the frames of the corrupted version of the video and the uncorrupted version of the video and an associated label into a data representation for training the machine learning model, the data representation including pixel values of the frame.
